(19) United States
(12) Patent Application Publication
(10) Pub. No.: US 2011/0178850 A1
(43) Pub. Date: Jul. 21, 2011

(54) FUTURE COST ESTIMATE FORECASTING FOR TECHNOLOGIES

(75) Inventors: Melissa STARK, Esher (GB); Charles JANS, Surrey (GB)

(73) Assignee: ACCENTURE GLOBAL SERVICES GMBH, Schaffhausen (CH)

(21) Appl. No.: 12/840,527

(22) Filed: Jul. 21, 2010

Related U.S. Application Data
(60) Provisional application No. 61/296,125, filed on Jan. 19, 2010.

(51) Int. Cl. G06Q 10/00

(52) U.S. Cl. 705/7.31

(57) ABSTRACT

A system for forecasting a future cost estimate for a technology includes a cost receipt unit configured to receive a first cost point and a second cost point identifying a starting cost at a first time period and a midpoint cost at a second time period, and calculate a third cost point to express the first cost point and the second cost point in a range of zero to one. The system also includes a base curve unit configured to determine a base S-curve from the first cost point, the second cost point and the third cost point. The system includes a weighting unit configured to receive weightings of cost-reduction drivers. The system includes a base curve adjustment unit configured to adjust the base S-curve based on the weightings of the cost-reduction drivers to create an adjusted S-curve.

### PRIORITY

This application claims priority to U.S. Provisional patent application Ser. No. 61/296,125, filed on Jan. 19, 2010, and entitled “S-Curve Methodology for the Valuation of Uncertainty in Disruptive Transport Fuel Technology”, which is incorporated by reference in its entirety.

### BACKGROUND

It is important for companies and other entities to determine the future costs and return on investment of a technology before committing to developing and implementing the technology. This is especially true of developing or nascent industries in which the technology's future is more uncertain.

Currently, many scholars, scientists, investors and economists attempt to value evolving technologies in developing industries in order to determine in which opportunity to invest. However, there is great difficulty in projecting future costs associated with new technologies in nascent industries.

Future cost estimates are generally based upon underlying assumptions of the scholars, scientists, investors and economists. Underlying assumptions may be factors and events that may affect the future cost estimates associated with a specific technology. For example, a scientist may determine a future cost estimate for a new technology that is dependent upon a particular breakthrough occurring for a manufacturing process to produce the innovation at the estimated future cost. If this breakthrough does not occur as anticipated, the future cost estimate for the new technology may be inaccurate. Therefore, the future cost estimates and return on investment determinations provided by scholars, scientists, investors and economists that are dependent upon underlying assumptions may be distorted.

### BRIEF SUMMARY OF THE INVENTION

According to an embodiment, a system for forecasting a future cost estimate for a technology includes a cost receipt unit configured to receive a first cost point and a second cost point identifying a starting cost at a first time period and a midpoint cost at a second time period, and calculate a third cost point to express the first cost point and the second cost point in a range. The system also includes a base curve unit configured to determine a base S-curve from the first cost point, the second cost point and the third cost point. A weighting unit configured to receive weightings of cost-reduction drivers and a base curve adjustment unit configured to adjust the base S-curve based on the weightings of the cost-reduction drivers to create an adjusted S-curve are also included in the system.

According to an embodiment, a method for forecasting a future cost estimate for a technology includes receiving a first cost point and a second cost point identifying a starting cost at a first time period and a midpoint cost at a second time period and calculating a third cost point to express the first cost point and the second cost point in a range. The method also includes determining a base S-curve from the first cost point, the second cost point and the third cost point; receiving weightings of cost-reduction drivers and adjusting the base S-curve based on the weightings of the cost-reduction drivers to create an adjusted S-curve.

The methods and functions described above may also be embodied as software stored on a computer readable storage device.

### BRIEF DESCRIPTION OF DRAWINGS

The embodiments of the invention will be described in detail in the following description with reference to the following figures.

FIG. 1 illustrates a system for forecasting a future cost estimate for a technology, according to an embodiment;

FIG. 2 illustrates a method for forecasting future cost estimates for technologies, according to an embodiment;

FIG. 3a illustrates an example of a first cost point and a second cost point for a disruptive technology, according to an embodiment;

FIG. 3b illustrates an example of a first cost point, a second cost point and a third cost point for a disruptive technology, according to an embodiment;

FIG. 4 illustrates a base S-curve, according to an embodiment;

FIG. 5 illustrates cost-reduction drivers divided into a yield category and a scale category, according to an embodiment;

FIG. 6 illustrates a comparison between a base S-curve and an adjusted S-curve, according to an embodiment; and

FIG. 7 illustrates a computer system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments. Also, the embodiments described herein may be used with each other in various combinations.

### 1. Overview

According to an embodiment, a logistic distribution methodology is used to forecast future manufacturing cost estimates. The logistic distribution methodology may be used to predict future manufacturing cost estimates for disruptive technologies, sometimes in nascent industries. Nascent industries are those that are just beginning or are in the early phases of developing. For example, the biofuels industry is a nascent industry. Disruptive technologies are those that may represent a significant improvement over current industry standard in terms of cost, performance or environmental impact.

To obtain more accurate future manufacturing cost estimates for disruptive technologies in nascent industries or any other technologies, the logistic distribution methodology is utilized, according to an embodiment. The logistic distribution methodology may include a logistic distribution probability distribution function (PDF). The logistic distribution PDF is a mathematical function that produces a bell curve of a normal distribution but with higher kurtosis (fatter tails). In one embodiment, a logistic distribution Cumulative Distribution Function (CDF) is a curve with an “S” shape, i.e. an S-curve.

Because industries inherently possess distinctive features that may drive down costs of manufacturing a disruptive technology over time, cost-reduction drivers are taken into account in forecasting the future manufacturing cost estimates using an adjusted S-curve, according to an embodiment. A relative influence of each cost-reduction driver may change based on events or new information and impact the base S-curve to create the adjusted S-curve. The changed cost-reduction drivers are applied to parameters of the base S-curve to create the adjusted S-curve. For example, the adjusted S-curve shifts the base S-curve based on changed parameters. This allows an independent assessment of future manufacturing cost estimates for the disruptive technologies and provides ease of use to those projecting future technologies. Furthermore, the system provides a cost projections as a result of faster processing.

A company may formulate future cost estimates for various disruptive technologies in order to compare them to one another. The company may use the future manufacturing cost estimates to determine in which disruptive technology to invest. The future manufacturing cost estimates may also be used in other systems for valuation and to determine investment levels. Future manufacturing cost estimates may also be used to determine return on investment.

According to an embodiment, a method for determining a base S-curve and an adjusted S-curve for a technology in an industry is provided. The method includes providing a user interface on a computer. The method also includes obtaining data with the user interface. The method further includes determining an adjusted midpoint, wherein the adjusted midpoint and weightings determine an adjusted base curve that is displayed on a screen on the user interface. In addition, the method includes storing the data in a database. Thus, the method may decrease the mental and physical effort required from a user in order to perform a task (e.g. storing data), since the user does not need to worry about where data is stored. In addition, the indicator may enable an improved, continued man-machine interaction, by facilitating the acquisition, display and storage of data.

Also, the system provides a technical tool for efficient and automated cost projections and curve determinations. Also, the arrangement of the base S-curve and the adjusted S-curve on the screen on the user interface is determined by technical considerations aimed at enhancing the user ability to manage the technical task of automating cost projections for technologies.

### 2. System

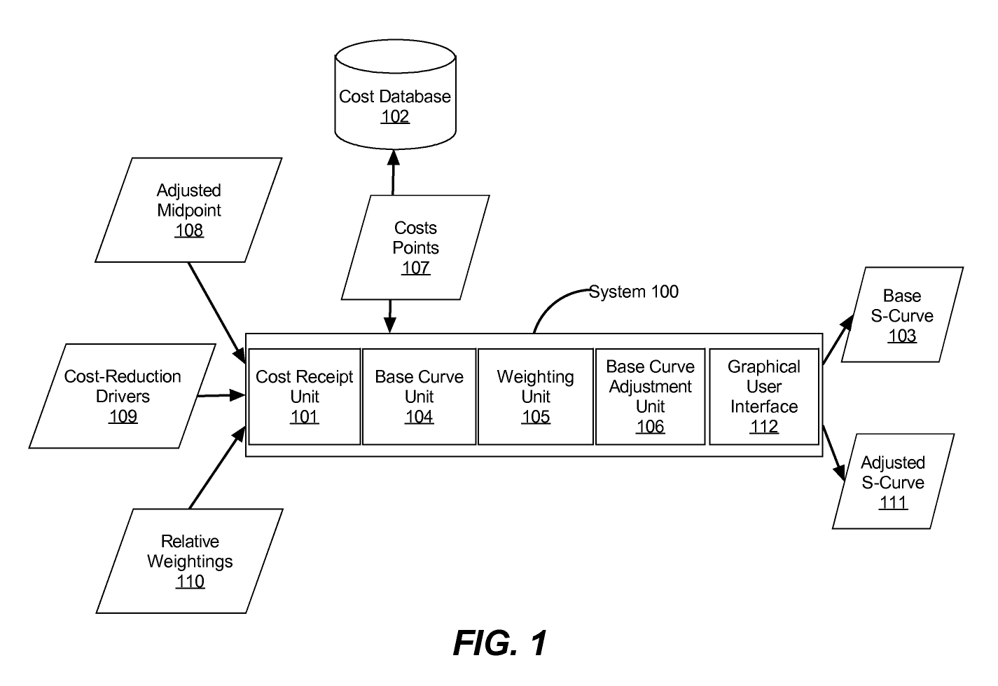

FIG. 1 illustrates system 100 for forecasting a future cost estimate for a disruptive technology in a nascent industry or any other technology, according to an embodiment. The system 100 includes cost receipt unit 101, base curve unit 104, weighting unit 105, base curve adjustment unit 106 and graphical user interface 112. A unit is a component of the system. The unit may be referred to as a module. The unit may be software, computer hardware, or a combination of both.

The cost receipt unit 101 receives at least two cost points 107, referred to as a first cost point and a second cost point, for at least two time periods for a disruptive technology. The first cost point is a short-term or starting manufacturing cost for a disruptive technology at a current time period or a time period shortly after a current time period. The first cost point includes two parameters, cost and time. For example, the short-term or starting manufacturing cost for a disruptive technology such as a biofuel may be $5/liter. The short-term or starting manufacturing cost may be received for the disruptive technology at a time period two years after the current time period. Two years may be the time period shortly after the current time period.

The second cost point is a midpoint or future manufacturing cost for the disruptive technology in a number of years after the current time period. The second cost point also includes two parameters, cost and time. For example, the midpoint or future manufacturing cost for the biofuel may be $2/liter. The midpoint or future manufacturing cost may be received for the disruptive technology at a time period ten years after the current time period. Ten years may be the time period that is a number of years after the current time period.

The first cost point and the second cost point may be received from an external source or retrieved from cost database 102, which may be internal or external to the system 100. The cost database 102 stores a plurality of first cost points and second cost points for various disruptive technologies. The first cost points and the second cost points stored in the cost database 102 may be collected from external sources such as academic studies, industry studies, companies, investor presentations, etc.

The first cost point and the second cost point for the disruptive technology may be expressed in a form in which a cost function is increasing over time in order to fit a base S-curve 103 to the first cost point and the second cost point. That is, the base S-curve 103 is inverted, such that the base S-curve 103 is descending.

Also, the first cost point and the second cost point are expressed in a range of [0-1], a condition for any probability distribution. For example, if the first cost point is $5/liter at two years and the second cost point is $2/liter at ten years, the first cost point and the second cost point do not meet the condition that they be expressed in a range of [0-1]. Therefore, the cost receipt unit 101 may calculate the first cost point and the second cost point as a percentage of potential improvement. To do this, the cost receipt unit 101 may either receive data for a third cost point or rely on a modeling assumption but into the system 100 to determine the third cost point. The third cost point is the cost of the disruptive technology at maturity, i.e. the cost at the bottom end of the base S-curve 103. If data is not received for the third cost point, the modeling assumption, that there is potential for the disruptive technology to improve beyond the second cost point, e.g. beyond the ten year mark in the example, is employed to calculate the third cost point. This is a modeling assumption instead of an underlying assumption since it is consistent with the observation above that more is known about technology in the short term than in the long term. For this example, it is assumed that there is a twenty percent improvement beyond the ten-year mark at the time period of maturity of the disruptive technology. At the ten year mark, the price was $2/liter. Multiplying $2/liter by 1.00-0.20 (showing a twenty percent improvement) results in $1.60/liter at the point of maturity. Thus, the third cost point is either determined or assumed at another time period beyond the second cost point that reflects the assumption.

The base curve unit 104 fits the base S-curve 103 to the first cost point, the second cost point and the third cost point based on the logistic distribution CDF. The formula for the logistic distribution CDF is given as follows:

$$f ( x , μ , σ ) = \frac{1}{1 + {e}^{- ( x - μ ) / σ}} \qquad Equation 1$$

In the equation above, the logistic distribution is a function of x, μ and σ, where x is the x-axis variable which represents the development of the disruptive technology over time (generally years), μ is the mean, and σ is the standard deviation. The constant e represents the base of the natural logarithm. A decimal approximation of e is 2.718281828.

To draw the base S-curve 103 over the whole domain of x (the total amount of time), the values of the mean (μ) and standard deviation (σ) are calculated by the base curve unit 104. The first logistic distribution CDF equation uses the time and cost parameters of the first cost point. The second logistic distribution CDF equation uses the time and cost parameters of the second point. Thus, the variable x is known for the first cost point and the second cost point, since the variable x represents the time parameter for the first cost point and the second cost point in each logistic distribution CDF equation. Because all of the variables and constants of the logistic distribution CDF are known except μ and σ, the two unknown variables μ and σ are derived by the base curve unit 104 by simultaneously solving two logistic distribution CDF equations. Thus, the first logistic distribution CDF equation is:

$$f ( 2 , μ , σ ) = \frac{1}{1 + {e}^{- ( 2 - μ ) / σ}} \qquad Equation 2$$

The second logistic distribution CDF equation is:

$$f ( 10 , μ , σ ) = \frac{1}{1 + {e}^{- ( 10 - μ ) / σ}} \qquad Equation 3$$

Once the first and second logistic distribution equations are simultaneously solved for μ and σ, the third cost point may be translated back to a non-percentage value by the base curve unit 104, e.g. $/liters values. The base curve unit 104 may then plot the non-percentage values of the first cost point, the second cost point and the third cost point over the domain of x using the derived μ and σ values. Of course, the percentage values may also be plotted to draw the base S-curve 103.

The weighting unit 105 receives an adjusted midpoint 108 for the disruptive technology. The weighting unit 105 may also receive cost-reduction drivers 109 for the disruptive technology and at least two relative weightings 110 for each of the cost-reduction drivers 109. The adjusted midpoint 108 is the amount of time the midpoint or the second cost point may adjust based on one of the cost-reduction drivers 109 (usually in years). For example, the adjusted midpoint 108 may be two years, indicating that the cost of the disruptive technology such as biofuel may be x amount two years later than indicated on the base S-curve 103. Thus, the weighting unit 105 receives the adjusted midpoint 108 and an indication as to which one or more of the cost-reduction drivers 109 to which the adjusted midpoint 108 is associated.

The weighting unit 105 also receives the cost-reduction drivers 109 for the disruptive technology and the relative weightings 110 for each of the received cost-reduction drivers 109. The relative weightings 110 represent the impact of the cost-reduction drivers 109 on manufacturing costs of the disruptive technology. There are at least two relative weightings 110 for each of the cost-reduction drivers 109. The first relative weighting is an individual weighting representing a percentage of the impact of the individual cost-reduction driver on manufacturing costs.

The second relative weighting is a category weighting. The received cost-reduction drivers 109 are grouped into a “yield” category or a “scale” category. Yield is a measure of productive efficiency in a manufacturing process. The cost-reduction drivers 109 that affect yield belong in the yield category. Scale is a measure of the production volume of a product. The cost-reduction drivers 109 that affect scale belong in the yield category. The second relative weighting represents the relative importance of each category, i.e. if the yield category has a greater impact on cost reduction, the yield category is more heavily weighted, and vice versa for the scale category. For some disruptive technologies, yield may have a greater impact; for others, the remaining cost reduction might be in the scale efficiencies.

Once the adjusted midpoint 108 and the relative weightings 110 for the cost-reduction drivers 109 are received, the base curve adjustment unit 106 adjusts the shape of the base S-curve 103 depending on the adjusted midpoint 108 and the relative weightings 110 to determine an adjusted S-curve 111. The adjusted S-curve 111 is determined by multiplying the adjusted midpoint 108 by the individual weighting of the cost-reduction driver associated with the adjusted midpoint 108 and the category weighting of the cost-reduction driver associated with the adjusted midpoint 108. The result of the multiplication is a new midpoint for the adjusted S-curve. The adjusted S-curve is then fitted to the first cost point, the new midpoint. The new midpoint of the adjusted S-curve 111 shifts the second cost point of the base S-curve 103 according to the weight of the associated cost-reduction driver. Thus, the adjusted S-curve 111 is created and the contribution of each cost-reduction driver is quantified.

The graphical user interface 112 may be software in the form of a dashboard or web-enabled. The graphical user interface 112 may be used to input the cost points 106, the adjusted midpoint 108, the cost-reduction drivers 109, and the relevant weightings 110 and to output the base S-curve 103 and the adjusted S-curve 111.

### 3. Method

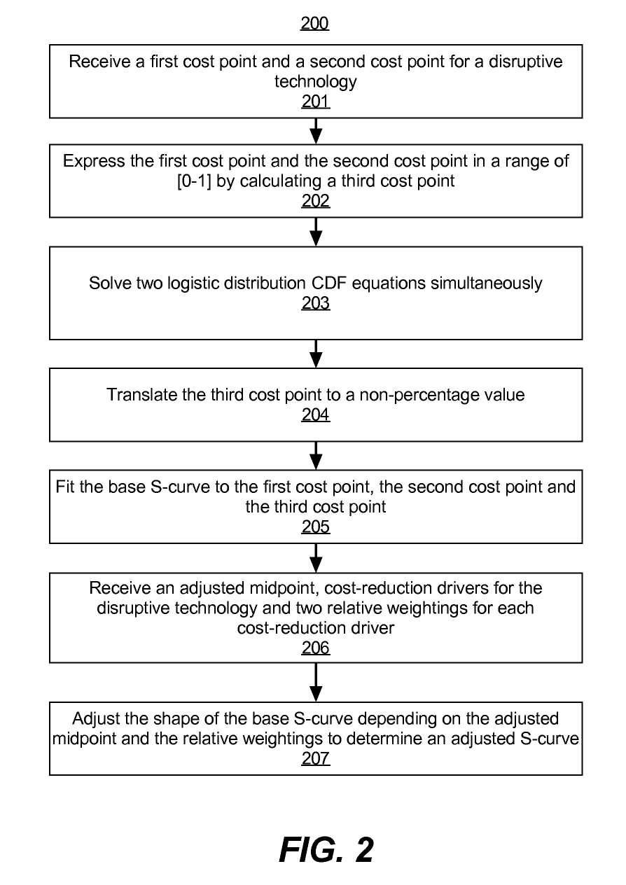

FIG. 2 illustrates method 200 for forecasting future cost estimates for disruptive technologies in a nascent industry, according to an embodiment. The method 200 may be implemented on the system 100 described above referring to FIG. 1 by way of example and not limitation. The method 200 may be practiced in other systems.

At step 201, the system 100 receives at least two cost points, a first cost point and a second cost point, for at least two time periods for a disruptive technology. The first and second cost points may include two parameters, such as cost and time. The first cost point may be a short-term or starting manufacturing cost and the second cost point may be a future cost point.

At step 202, the system 100 expresses the first cost point and the second cost point in a range of [0-1], a condition for any probability distribution. The system 100 may calculate the first cost point and the second cost point as a percentage of potential improvement. To do this, the system 100 may either receive data for a third cost point or rely on a modeling assumption built into the system 100 to determine the third cost point. The third cost point is the cost of the disruptive technology at maturity, i.e. the cost at the bottom end of the base S-curve. If data is not received for the third cost point, the modeling assumption, that there is potential for the disruptive technology to improve beyond the second cost point, is employed to calculate the third cost point. The third cost point is assumed to be a percentage of improvement at another time period beyond the second cost point that reflects the assumption. The third cost point is determined by subtracting the percentage of improvement from 1.00 and multiplying the result of the subtraction with the price parameter of the second cost point. Also at step 202, a base S-curve is inverted, such that the base S-curve is descending.

At step 203, the system 100 simultaneously solves two logistic distribution CDF equations. For example, the formula for the logistic distribution may be Equation 1 described above. As stated above, the first logistic distribution CDF equation uses the time and cost parameters of the first cost point. The second logistic distribution CDF equation the time and cost parameters of the second point. Thus, the variable x is known for the first cost point and the second cost point, since the variable x represents the time parameter for the first cost point and the second cost point in each logistic distribution CDF equation. Because all of the variable and constants of the logistic distribution CDF are known except μ and σ, the two unknown variables μ and σ are derived by the system 100 by simultaneously solves two logistic distribution CDF equations.

At step 204, the system 100 translates the third cost point to a non-percentage value.

At step 205, the system 100 fits the base S-curve to the first cost point, the second cost point and the third cost point. The system 100 plots the non-percentage values of the first cost point, the second cost point and the third cost point over the domain of x using the derives μ and σ values for the base S-curve.

At step 206, the system 100 receives an adjusted midpoint, cost-reduction drivers and at least two relative weightings for each of the cost-reduction drivers. The adjusted midpoint is the amount of time the midpoint or the second cost point may be adjusted based on one of the cost-reduction drivers. The adjusted midpoint accounts for an impact of one or more of the received cost-reduction drivers. For example, the weighting unit 105 receives the adjusted midpoint and an indication as to which one or more of the cost-reduction drivers to which the adjusted midpoint is associated. The relative weightings represent the impact of the cost-reduction drivers on manufacturing costs. The first relative weighting is an individual weighting representing a percentage of the impact of the individual cost-reduction driver on manufacturing costs. The second relative weighting is a category weighting. The received cost-reduction drivers are grouped into a “yield” category or a “scale” category.

At step 207, the system 100 adjusts the shape of the base S-curve depending on the adjusted midpoint and the relative weightings to determine an adjusted S-curve. The adjusted S-curve is determined by multiplying the adjusted midpoint by the individual weighting of the cost-reduction driver associated with the adjusted midpoint and the category weighting of the cost-reduction driver associated with the adjusted midpoint. The result of the multiplication is a new midpoint for the adjusted S-curve. The adjusted S-curve is then fitted to the first cost point, the new midpoint. The new midpoint of the adjusted S-curve shifts the second cost point of the base S-curve according to the weight of the associated cost-reduction driver. Thus, the adjusted S-curve is created.

The method 200 may be performed with data for several disruptive technologies in order to determine future manufacturing cost estimates for each disruptive technology. Based on this collective data, a company may be able to determine which disruptive technology in which to invest.

### 4. Example

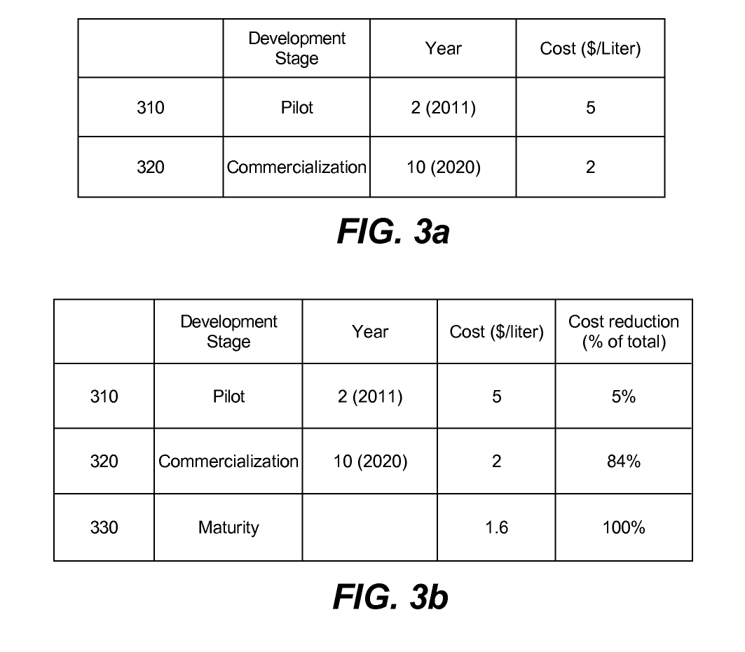

FIGS. 3-6 illustrate an example of the method 200 for forecasting future cost estimates for disruptive technologies in a nascent industry.

Examples of the first cost point and the second cost point for a disruptive technology in the biofuels industry is shown in FIG. 3a. In FIG. 3a, the disruptive technology in the pilot development stage, item 310, is produced at year two at a cost of $5/liter. The disruptive technology in the commercialization development stage, item 320, is produced at year ten at a cost of $2/liter.

As described above, the system 100 may either receive data for a third cost point or rely on a modeling assumption built into the system 100 to determine the third cost point. The first and second cost points 310 and 320 are shown and an example of a third cost point 330 for the disruptive technology in the biofuels industry is shown in FIG. 3b. In FIG. 3b, the disruptive technology in the pilot development stage, item 310, is produced at year two at a cost of $5/liter and experiences a cost reduction of 5%. The disruptive technology in the commercialization development stage, item 320, is produced at year ten at a cost of $2/liter and experiences a cost reduction of 5%. The disruptive technology in the maturity development stage, item 330, is produced at a cost of $1.60/liter and experiences a cost reduction of 100%. The cost reduction for each of the cost points 310-330 may be a comparison of cost per liter from an initial cost point to the cost points 310-330, respectively.

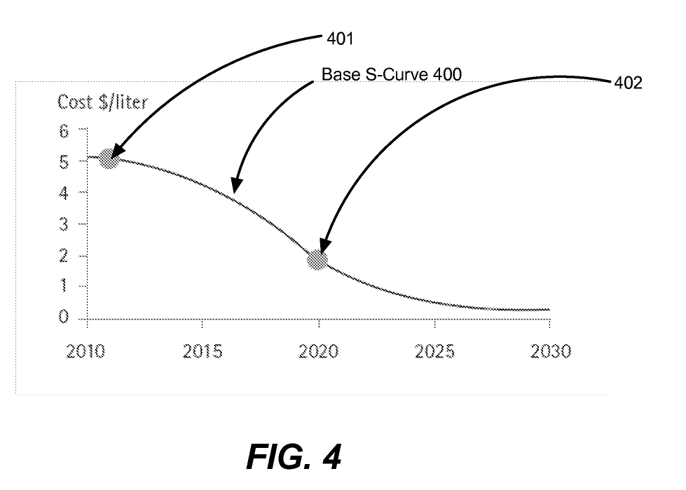

The system 100 fits the base S-curve to the first cost point, the second cost point and the third cost point. FIG. 4 is an illustration of a base S-curve 400 based on the data in FIG. 3b. The x-axis represents development time in terms of years. The y-axis represents cost of the disruptive technology, e.g. a biofuel in terms of $/liters. Item 401 represents the time and cost parameters of the first cost point 310 and item 402 represents the time and cost parameters of the second cost point 320 on the base S-curve 400.

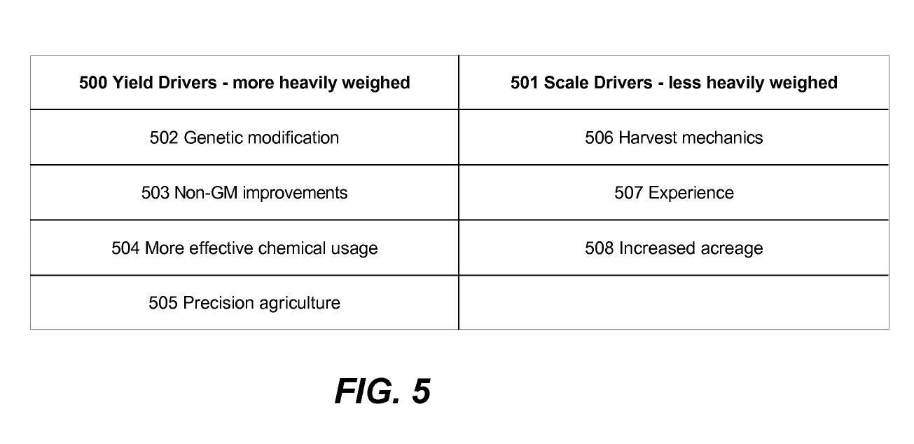

The system 100 receives an adjusted midpoint, cost-reduction drivers and at least two relative weightings for each of the cost-reduction drivers. FIG. 5 illustrates cost-reduction drivers divided into a yield category 500 called “Yield drivers” and a scale category 501 called “Scale drivers”. The yield category 500 includes genetic modification 502, non-GM improvements 503, more efficient chemical usage 504 and precision agriculture 505. The scale category 501 includes harvesting mechanics 506, experience 507 and increased acreage 508. FIG. 5 indicates the yield category 500 is more heavily weighted than the scale category 501 because the yield category 500 may have a larger impact on cost reduction.

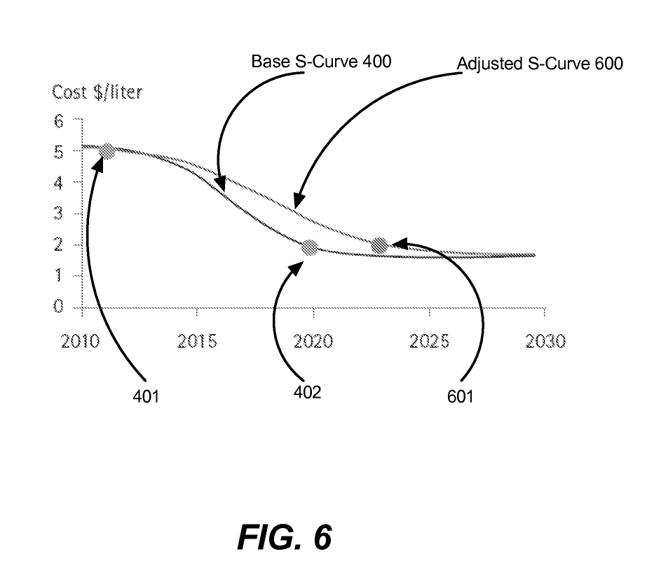

FIG. 6 shows a comparison between the base S-curve 400 and an adjusted S-curve 600. The x-axis represents development time in terms of years. The y-axis represents cost of the disruptive technology, e.g. a biofuel in terms of $/liters. Item 401 represents the time and cost parameters of the first cost point 310 and item 402 represents the time and cost parameters of the second cost point 320 on the base S-curve 400. Item 601 represents the second cost point 320 on the adjusted S-curve 600. The adjusted S-curve 600 has clearly shifted because of the effect of the cost-reduction drivers on the weightings and in turn on the time and cost parameters for the second cost point 601.

### 5. Computer System

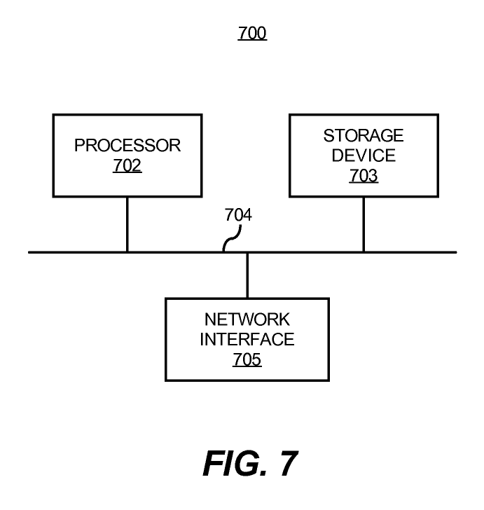

FIG. 7 shows a computer system 700 that may be used as a hardware platform for the system 100. The computer system 700 may be used as a platform for executing one or more of the steps, methods, and functions described herein that may be embodied as software stored on one or more computer readable storage devices, which are hardware storage devices.

The computer system 700 includes a processor 702 or processing circuitry that may implement or execute software instructions performing some or all of the methods, functions and other steps described herein. Commands and data from the processor 702 are communicated over a communication bus 704. The computer system 700 also includes a non-transitory computer readable storage device 703, such as random access memory (RAM), where the software and data for processor 702 may reside during runtime. The storage device 703 may also include non-volatile data storage. The computer system 700 may include a network interface 705 for connecting to a network. It will be apparent to one of ordinary skill in the art that other known electronic components may be added or substituted in the computer system 700.

While the embodiments have been described with reference to examples, those skilled in the art will be able to make various modifications to the described embodiments without departing from the scope of the claimed embodiments. Also, the embodiments described herein may be used to determine future costs of any technology in any industry, costs of services in various industries, costs of pharmaceuticals over time, etc.

What is claimed is:

1. A system for forecasting a future cost estimate for a technology, comprising:
a cost receipt unit configured to
receive a first cost point and a second cost point identifying a starting cost at a first time period and a midpoint cost at a second time period, and
calculate a third cost point to express the first cost point and the second cost point in a range;
a base curve unit configured to determine a base S-curve from the first cost point, the second cost point and the third cost point;
a weighting unit configured to receive weightings of cost-reduction drivers; and
a base curve adjustment unit configured to adjust the base S-curve based on the weightings of the cost-reduction drivers to create an adjusted S-curve.

2. The system of claim 1, wherein the base S-curve and the adjusted S-curve are descending S-curves.

3. The system of claim 1, wherein the weighting unit is further configured to receive an adjusted midpoint and an indication as to which one of the cost-reduction drivers is associated to the adjusted midpoint.

4. The system of claim 3, wherein base curve adjustment unit is further configured to multiply the adjusted midpoint by the weightings for the cost-reduction driver associated with the adjusted midpoint.

5. The system of claim 1, wherein the weightings include an individual weighting for each cost-reduction driver and a category weighting for a plurality of cost-reduction drivers.

6. The system of claim 1, wherein the range is a range of zero to one.

7. The system of claim 1, wherein the technology comprises technology from the biofuels industry, the engine technology industry, the renewable power technology or the battery industry.

8. A method for forecasting a future cost estimate for a technology, comprising:
receiving a first cost point and a second cost point identifying a starting cost at a first time period and a midpoint cost at a second time period;
calculating a third cost point to express the first cost point and the second cost point in a range;
determining, using a processor, a base S-curve from the first cost point, the second cost point and the third cost point;
receiving weightings of cost-reduction drivers; and
adjusting the base S-curve based on the weightings of the cost-reduction drivers to create an adjusted S-curve.

9. The method of claim 8, wherein the base S-curve and the adjusted S-curve are descending S-curves.

10. The method of claim 8, further comprising receiving an adjusted midpoint and an indication as to which one of the cost-reduction drivers is associated to the adjusted midpoint.

11. The method of claim 10, adjusting the base S-curve further comprises multiplying the adjusted midpoint by the weightings for the associated cost-reduction driver associated with the adjusted midpoint.

12. The method of claim 8, wherein the weightings include an individual weighting for each cost-reduction driver and a category weighting for a plurality of cost-reduction drivers.

13. The method of claim 12, wherein the category weighting may be a scale weighting or a yield weighting.

14. The method of claim 8, wherein the range is a range of zero to one.

15. A non-transitory computer readable storage device having stored thereon a computer executable program for forecasting a future cost estimate for a technology, the computer executable program, when executed causes a computer to system to implement:
receiving a first cost point and a second cost point identifying a starting cost at a first time period and a midpoint cost at a second time period;
calculating a third cost point to express the first cost point and the second cost point in a range;
determining a base S-curve from the first cost point, the second cost point and the third cost point;
receiving weightings of cost-reduction drivers and a new midpoint time period; and
adjusting the base S-curve based on the weightings of the cost-reduction drivers to create an adjusted S-curve.

16. The computer readable storage device of claim 15, wherein the base S-curve and the adjusted S-curve are descending S-curves.

17. The computer readable storage device of claim 15, further comprising receiving an adjusted midpoint and an indication as to which one of the cost-reduction drivers is associated to the adjusted midpoint.

18. The computer readable storage device of claim 17, adjusting the base S-curve further comprises multiplying the adjusted midpoint by the weightings for the associated cost-reduction driver associated with the adjusted midpoint.

19. The computer readable storage device of claim 15, wherein the weightings include an individual weighting for each cost-reduction driver and a category weighting for a plurality of cost-reduction drivers.

20. The computer readable storage device of claim 19, wherein the category weighting may be a scale weighting or a yield weighting.
